(19) United States
(12) Patent Application Publication
(10) Pub. No.: US 2012/0221363 A1
(43) Pub. Date: Aug. 30, 2012

(54) SYSTEM AND METHOD FOR DISPLAYING HOTEL INFORMATION

(75) Inventors: Christopher Brian Slowe, San Francisco, CA (US); Steven Ladd Huffman, San Francisco, CA (US); Adam Julian Goldstein, San Francisco, CA (US)

(73) Assignee: Hipmunk, Inc., San Francisco, CA (US)

(21) Appl. No.: 13/399,879

(22) Filed: Feb. 17, 2012

Related U.S. Application Data
(60) Provisional application No. 61/446,562, filed on Feb. 25, 2011.

(51) Int. Cl. G06Q 10/02

(52) U.S. Cl. 705/5

(57) ABSTRACT

When searching for accommodations, although one or more accommodations may satisfy factors or criteria set by a traveler (e.g., a user), the traveler may desire to locate an accommodation that is also in a convenient area. A convenient area may be an area in which a concentration of points of interest (POIs) is high. For example, a traveler on a leisure trip may desire to stay at a hotel that is in an area with a relatively high concentration of restaurants or tourist attractions, or as a traveler on a business trip may desire to stay at a hotel near an airport or convention hall. Thus, some example embodiments provide accommodation search results to one or more users based on a concentration of points of interest. The accommodation search results may be provided graphically, textually, or any suitable combination thereof.

### RELATED APPLICATION

This application claims the priority benefit of U.S. Provisional Patent Application No. 61/446,562, filed Feb. 25, 2011, which is incorporated herein by reference in its entirety.

TECHNICAL FIELD

The subject matter disclosed herein generally relates to the processing of data. Specifically, the present disclosure addresses systems and methods of displaying accommodation information (e.g., hotel information).

### BACKGROUND

A hotel may operate a hotel website that allows a user to request and view information about that hotel. Such a hotel website may be useful in situations where the user has identified the hotel and desires to request and view the information about that hotel.

### BRIEF DESCRIPTION OF THE DRAWINGS

Some embodiments are illustrated by way of example and not limitation in the figures of the accompanying drawings.

FIG. 1 is a block diagram illustrating a network, according to some embodiments.

FIG. 2 is a flowchart of operations in a method of identifying hotels based on a concentration of points of interest, according to some example embodiments.

FIG. 3 is a flowchart of operations in a method of generating a heat map corresponding to a concentration of points of interest, according to some example embodiments.

FIG. 4 is a flowchart of operations in a method of displaying data for hotels and heat maps on a geographic map in a user interface of a client computer system, according to some example embodiments.

FIG. 5 is a flowchart of operations in a method of calculating hotel quality factors and hotel room values, according to some example embodiments.

FIG. 6 depicts a block diagram of an example machine that is configurable to perform any one or more the methodologies discussed herein, according to some example embodiments.

FIG. 7 is a screenshot illustrating a user interface for presenting one or more hotel search results, according to some example embodiments.

FIG. 8 is a screenshot illustrating a heat map superimposed on a geographic map, according to some example embodiments.

FIG. 9 is a screenshot illustrating clusters of hotels at a first zoom level, according to some example embodiments.

FIG. 10 is a screenshot illustrating clusters of hotels at a second zoom level, according to some example embodiments.

FIG. 11 is a screenshot illustrating a result of a contextual zoom-out operation, according to some example embodiments.

Like reference numerals refer to corresponding parts throughout the drawings.

### DETAILED DESCRIPTION

Example methods and systems are directed to displaying hotel information. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

When searching for accommodations (e.g., hotels, motels, hostels, apartment rentals, home rentals, or other forms of accommodation), a traveler may be presented with one or more accommodations that are sorted by one or more factors such price, hotel rating (e.g., a customer rating about a hotel), distance from a particular geographic location (e.g., the city center, distance from a point of interest, etc.), average distance from several particular geographic locations (e.g., locations of several scheduled meetings on the traveler's electronic calendar), availability of rooms, and the like. Although an accommodation may satisfy one or more of these factors, a traveler may desire to locate an accommodation that is also in a convenient area. A convenient area may be an area in which a concentration of points of interest (POIs) is high. For example, a traveler on a leisure trip may desire to stay at an accommodation that is in an area with a relatively high concentration of restaurants or tourist attractions. Existing accommodation search tools (e.g., hotel search tools) do not provide travelers with a way to select accommodations based on the concentration of points of interest. For clarity, discussion herein focuses on hotels, as examples of accommodations. However, the methods and systems discussed herein apply equally well to any type of accommodations or combination thereof.

Thus, some example embodiments provide hotel search results to one or more users based on a concentration of points of interest. The hotel search results may be provided graphically (e.g., on a geographic map, etc.), textually (e.g., in a list form), or any suitable combination thereof.

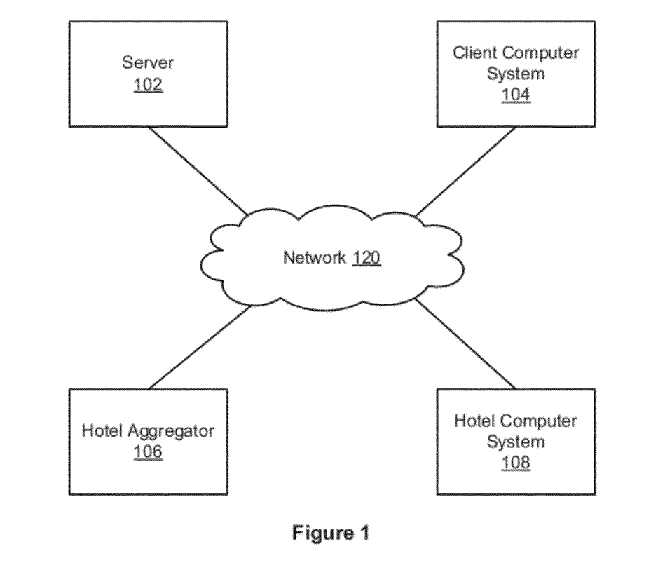

FIG. 1 is a block diagram illustrating a network 120, according to some example embodiments. The network 120 may generally include any type of wired or wireless communication channel capable of coupling together one or more computing nodes. This includes, but is not limited to, a local area network, a wide area network, or a combination of networks. In some embodiments, the network 120 includes the Internet.

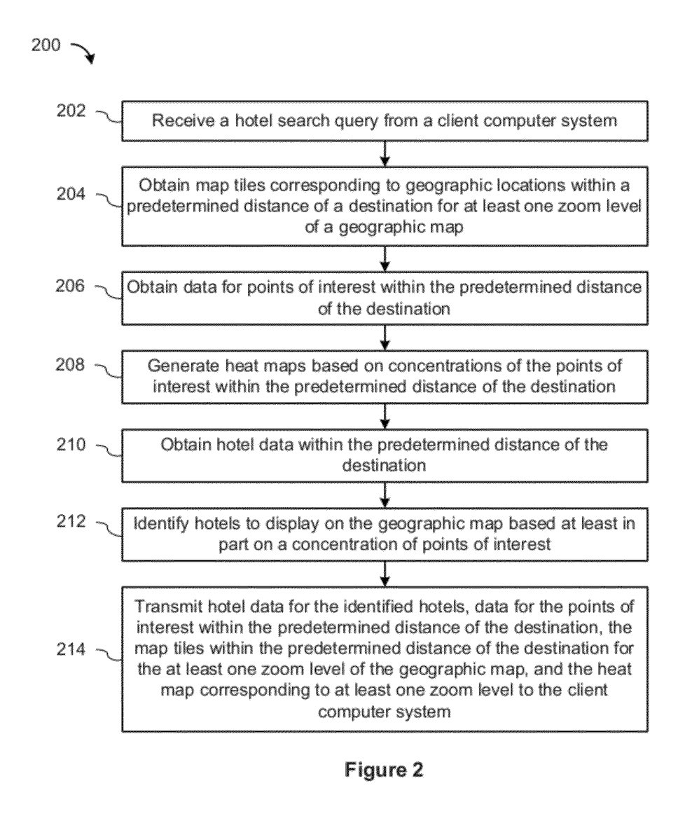

A server 102 and a client computer system 104 may be coupled to each other via the network 120. The client computer system 104 may be operated by a traveler (e.g., a user) searching for hotel rooms at one or more particular destinations. The server 102 and the client computer system 104 are described in more detail below with respect to FIG. 2-6.

In some example embodiments, a hotel computer system 108 is coupled to network 120. The hotel computer system 108 may provide hotel data to the server 102, the client computer system 104, or both. The hotel data for a hotel is descriptive of the hotel and may include one or more of a geographic location of the hotel (e.g., a global position system coordinate of the hotel, etc.), a name of the hotel, a rating of the hotel, a description of one or more amenities of the hotel, room data of the hotel (e.g., dates the rooms are available, number of occupants for the rooms, room types, etc.), a hotel chain or hotel alliance to which the hotel belongs, a hotel brand, or any suitable combination thereof.

In some embodiments, a hotel aggregator 106 is coupled to network 120. The hotel aggregator 106 may be a computer system that aggregates hotel data and provides the aggregated hotel data to the server 102, the client computer system 104, or both. The hotel aggregator 106 may obtain the hotel data from the hotel computer system 108.

Although only a single instance of the server 102, the client computer system 104, the hotel aggregator 106, and the hotel computer systems 108 are illustrated in FIG. 1, any number of these systems may be present. For example, the server 102 may include a plurality of distributed servers (e.g., distributed geographically, distributed within a data center, etc.). Similarly, the client computer system 104 may be one of a plurality of client computer systems operated by travelers (e.g., users).

FIG. 2 is a flowchart of operations in a method 200 of identifying one or more accommodations (e.g., hotels) based, at least in part, on a concentration of points of interest, according to some example embodiments.

The server 102 may receive (at operation 202) a hotel search query from the client computer system 104 (e.g., from a traveler using the client computer system 104). The hotel search query may include one or more of a destination (e.g., a city, a state, a region, a neighborhood, an airport, a seaport, a train station, a point of interest, a building, an address, a stadium, a venue, a theater, a restaurant, an amusement park, a tourist attraction, a resort, a conference facility, or any suitable combination thereof), a check in date, a check out date, a number of occupants (e.g., a number of adults and a number of children), a number of rooms, a price range (e.g., maximum price, minimum price, average price, etc.), a maximum distance from a destination, or any suitable combination thereof.

The server 102 may obtain (at operation 204) map tiles corresponding to geographic locations within a vicinity of a destination for at least one zoom level of a geographic map. In some example embodiments, the destination has a specific geographic location (e.g., an address or global positioning system coordinates that correspond to the destination itself or to a representative point within the destination), and the server 102 may obtain map tiles corresponding to geographic locations within a predetermined distance of the destination. Such a predetermined distance may be the maximum distance specified in the hotel search query or may be a default distance specified by the server 102. In some example embodiments, the server 102 obtains map tiles within the predetermined distance of the destination for all possible zoom levels of the geographic map. In some embodiments, the server 102 obtains map tiles within the predetermined distance of the destination for a subset of the possible zoom levels of the geographic map.

The server 102 may obtain (at operation 206) data for points of interest in the vicinity (e.g., within the predetermined distance) of the destination. The data for a point of interest may include one or more of a geographic location of the point of interest (e.g., a global positioning system coordinate, etc.), a point of interest type, a name of the point of interest, a link to a web page associated with the point of interest, a phone number associated with the point of interest, a description of the point of interest, or any suitable combination thereof. The data for the points of interest may be obtained from data providers or via online resources (e.g., online encyclopedias, online city guides, online yellow pages, etc.).

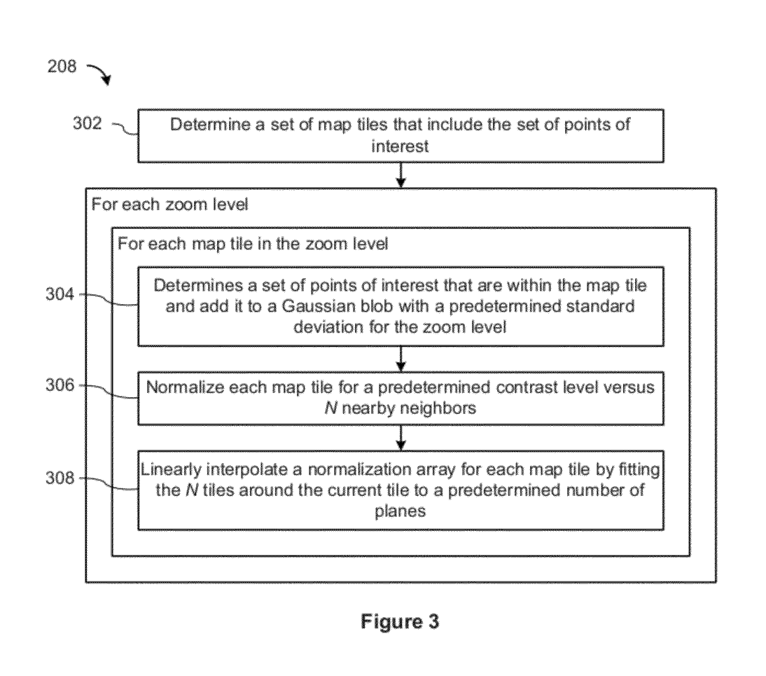

The server 102 may generate (at operation 208) one or more heat maps based on one or more concentrations of the points of interest within the vicinity (e.g., within the predetermined distance) of the destination. The process of generating heat maps is described in more detail with respect to FIG. 3 below.

The server 102 may obtain (at operation 210) hotel data indicative of one or more hotels within the vicinity (e.g., within the predetermined distance) of the destination. The hotel data may include one or more of a geographic location of a hotel (e.g., a global position system coordinate of the hotel, etc.), a name of the hotel, a rating of the hotel, amenities of the hotel, room data of the hotel (e.g., dates the rooms are available, number of occupants for the rooms, room types, etc.), or any suitable combination thereof.

The server 102 may identify (at operation 212) one or more hotels to display on the geographic map based at least in part on a concentration of points of interest. The server 102 may identify the hotels to display on the geographic map based on subsets of the points of interests. For example, the server 102 may identify hotels to display on the geographic map based on a concentration of restaurants and tourist attractions. Similarly, the server 102 may identify hotels to display on the geographic map based on a concentration of night clubs. In some embodiments, the server 102 identifies multiple sets of hotels to display on the geographic map, each set corresponding to a concentration of a particular combination of points of interest.

The server 102 may transmit (at operation 214) some or all of the hotel data for the identified hotels, some or all of the data for the points of interest within the vicinity (e.g., within the predetermined distance) of the destination, some or all of the map tiles within the vicinity (e.g., within the predetermined distance) of the destination for at least one zoom level of the geographic map, one or more heat maps corresponding to at least one zoom level to the client computer system 104, or any suitable combination thereof. In some example embodiments, the hotel data for the identified hotels includes a sorted list of hotels for at least one zoom level of the geographic map.

In some example embodiments, to speed up response time on the client computer system 104, the server 102 transmits hotel data for the identified hotels, the data for the points of interest within the vicinity (e.g., within the predetermined distance) of the destination, the map tiles, and the heat map corresponding to a plurality of zoom levels of the geographic map and a plurality of points of interest filter settings. The server 102 may transmit the hotel data to the client computer system 104. A traveler using the client computer system 104 may use a point of interest filter setting to select a particular point of interest (or a combination of points of interest) to filter out the hotel search results returned by the server 102.

According to various example embodiments, since points of interest generally do not change very often, operations 206-208 may be performed periodically or otherwise independently of the hotel search query. For example, the server 102 may generate new heat maps periodically (e.g., every hour, every day, etc.) regardless of whether a traveler has submitted a hotel search query. In doing so, the response time for transmitting a heat map to the user may be reduced due to the server 102 transmitting a pre-computed or cached version of the heat map to the client computer system 104, instead of generating a new heat map in response to the receiving the search query from the client computer system 104.

The order of operations illustrated in FIG. 2 is merely an example embodiment. Some operations may be performed in a different order than as shown in FIG. 2. For example, operations 210-212 may be performed prior to operations 206-208. In some example embodiments, the heat maps discussed above with respect to operation 208 may be generated (e.g., as one or more map tiles, which may be cached for quick loading in response to a search query) prior to the receiving of the hotel search query in operation 202.

FIG. 3 is a flowchart of operations and a method of generating a heat map (e.g., operation 208) corresponding to a concentration of points of interest, according to some example embodiments. As used herein, a “heat map” is a graphical representation (e.g., an image or group of images) that indicates one or more densities or concentrations of objects (e.g., points of interest). A “density” or “concentration” of objects herein refers to a number of such objects within a geographic area or region (e.g., a map tile of a geographic map). For example, a heat map that indicates a concentration of multiple points of interest may be a graphical representation of a geographic map (e.g., a two-dimensional aerial view of a city) in which a particular portion of the geographic map (e.g., showing a neighborhood within the city) is depicted as having many points of interests located therein. Accordingly, a heat map may be indicative of a concentration of points of interest.

The server 102 may determine (at operation 302) a set of map tiles that include the set of points of interest.

For each map tile in a zoom level, the server 102 may determine (at operation 304) a set of points of interest that are within the map tile, and the server 102 may add the set of points of interest to multi-dimensional distribution curve (e.g., a Gaussian blob) with a predetermined standard deviation (e.g., sigma) for the zoom level. According to various example embodiments, the process of adding the set of points of interest to a Gaussian blob may be performed by the server 102 as follows. The server 102 may initialize a final array (e.g., by creating an empty array) that is a 2-dimensional array corresponding to a bitmap that is used to represent a heat map for the map tile (e.g., a portion of the whole heat map that corresponds to the map tile). The server 102 may construct an exemplary feature array that is a 2-dimensional array corresponding to an exemplary feature point in which the values of the array elements are determined by a two-dimensional Gaussian distribution having the predetermined standard deviation. This exemplary feature array may be used for all points of interest for the zoom level. For each point of interest in the set of points of interest, the server 102 may add the values of the elements of the exemplary feature array to the values of the elements of the final array so that the center element of the exemplary feature array corresponds to the location of the point of interest in the final array. The server 102 may repeat this process for each point of interest, including points of interest that are not within the map tile but that are on one of the eight neighboring map tiles. Processing points of interest in the eight neighboring map tiles may facilitate prevention of boundary discontinuities.

The predetermined standard deviation may be determined by the server 102 as follows. A default standard deviation, σ₀, may be determined for a default zoom level, Z₀, of the geographic map. For example, if Z₀ for a geographic map is 12, σ₀ may correspond to a predetermined distance (e.g., 0.5 miles). When increasing the zoom level (e.g., zooming in), the predetermined standard deviation, σᵢ, for a zoom level i may be determined as:

σᵢ=σ₀2^{Z}^{₀}^{-Z}^{ᵢ}.

Since Z₀ is smaller than Zᵢ, σ₀ is decreased, and each point of interest is more distinguishable on the heat map. When decreasing the zoom level (e.g., zooming out), σᵢ may be determined as:

σᵢ=σ₀1.4^{Z}^{₀}^{-Z}^{ᵢ}.

In some situations, zoom levels on a geographic map differ by a factor of 2. Thus, as the zoom level decreases by a power of 2 (e.g., zooming out), σᵢ increases by a factor of 1.4. Accordingly, as the zoom level decreases, points of interest on the heat map start to merge together. Even at the lowest zoom level (e.g., zoom level 1, which may correspond to the whole world), cities may remain separate since σ₁ corresponds to a distance of approximately 25 miles on the geographic map.

The server 102 may then normalize (at operation 306) each map tile for a predetermined contrast level versus N nearby neighbors. In some example embodiments, N is between 1 and 8, inclusive. In these embodiments, N is higher when the zoom level is higher (e.g., the map is zoomed in) to account for the need for more surface area when computing the “local” maximum of the heat map.

The server 102 may then linearly interpolate (at operation 308) a normalization array for each map tile (e.g., by fitting the N map tiles around the current map tile to a predetermined number of planes). For example, the predetermined number of planes may be 4 planes (e.g., one for each quadrant of the tile). This process of normalization may facilitate ensuring that the normalization array is continuous across map tile boundaries. This process of normalization also may have two additional effects: (1) the map tiles may be locally normalized and (2) the normalization may be very different across larger distances (e.g., intercity) but the contrast may be correspondingly high.

The server may then repeat operations 304-308 for each possible zoom level.

In some example embodiments, the server 102 generates a heat map based on a particular type of point of interest (or combination of points of interests). For example, the server 102 may generate a heat map based on a concentration of restaurants. Similarly, the server 102 may generate a heat map based on a concentration of tourist attractions and restaurants. A traveler (e.g., a user) may use a point of interest filter setting in the user interface of the client computer system 104 to select a heat map to be displayed.

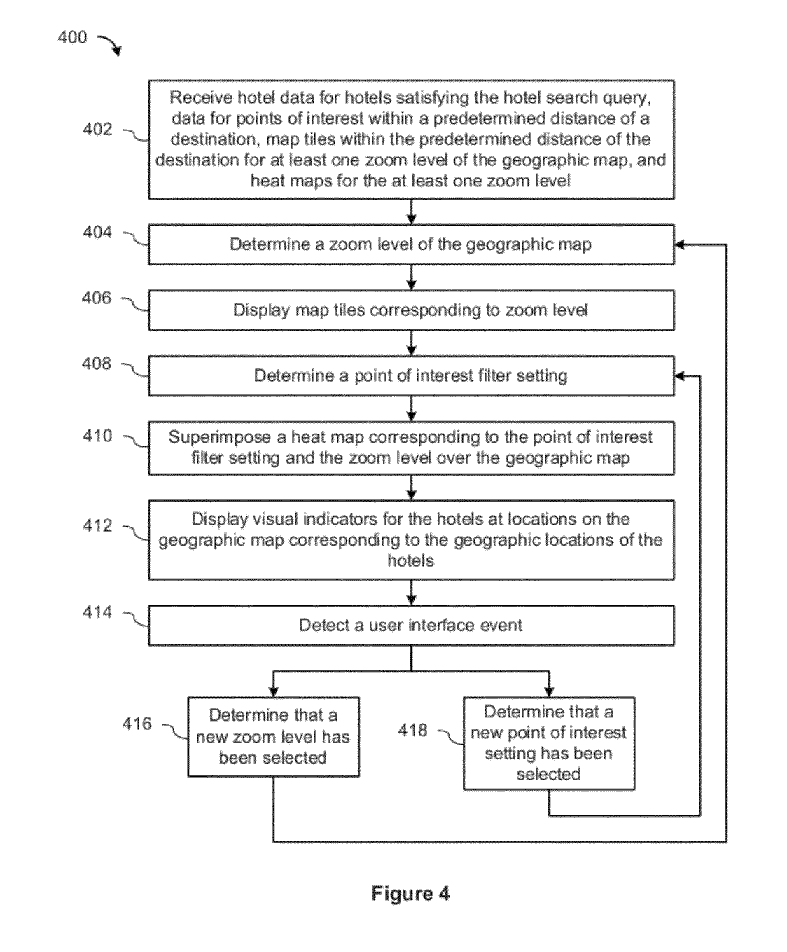

FIG. 4 is a flowchart of operations in a method 400 of displaying data for accommodations (e.g., hotels) and heat maps on a geographic map in a user interface of the client computer system 104, according to some example embodiments.

The client computer system 104 may receive (at operation 402) hotel data for one or more hotels satisfying the hotel search query, data for one or more points of interest within a predetermined distance of a destination, one or more map tiles within the vicinity (e.g., within the predetermined distance) of the destination for at least one zoom level of the geographic map, one or more heat maps for the at least one zoom level, or any suitable combination thereof, from the server 102.

The client computer system 104 may determine (at operation 404) a zoom level of the geographic map.

The client computer system 104 may display (at operation 406) one or more map tiles corresponding to the zoom level in the user interface of the client computer system 104.

The client computer system 104 may determine (at operation 408) a point of interest filter setting.

The client computer system 104 may superimpose (at operation 410) a heat map corresponding to the point of interest filter setting and the zoom level over the geographic map.

The client computer system 104 may display (at operation 412) one or more visual indicators for the one or more hotels at one or more locations on the geographic map corresponding to the geographic locations of the hotels.

The client computer system 104 may detect (at operation 414) a user interface event (e.g., an event within the user interface). When the client computer system 104 determines (at operation 416) that a new zoom level has been selected, the client computer system 104 may return to operation 404. When the client computer system 104 determines (at operation 418) that a new point of interest setting has been selected, the client computer system 104 may return to operation 408.

In some example embodiments, a list of hotels sorted by the concentration of points of interest is displayed to the traveler in the user interface of the client computer system 104. In these embodiments, the list of hotels may be displayed concurrently with the geographic map (e.g., in a side bar, etc.) or in lieu of the geographic map. Similar to the process discussed above, the traveler may select a new point of interest filter setting. In response to the new point of interest filter setting, the client computer system 104 may display a list of hotels corresponding to the selected point of interest filter setting. For example, if the traveler is interested in filtering out hotels based on the concentration of restaurants, the data for the hotels to be displayed maybe filtered accordingly and the list of hotels (e.g., sorted by distance to concentrations of restaurants) may be displayed.

According to various example embodiments, the display of one or more heat maps may be turned off by the traveler. In doing so, the client computer system 104 may display the geographic map without some or all of the available heap maps.

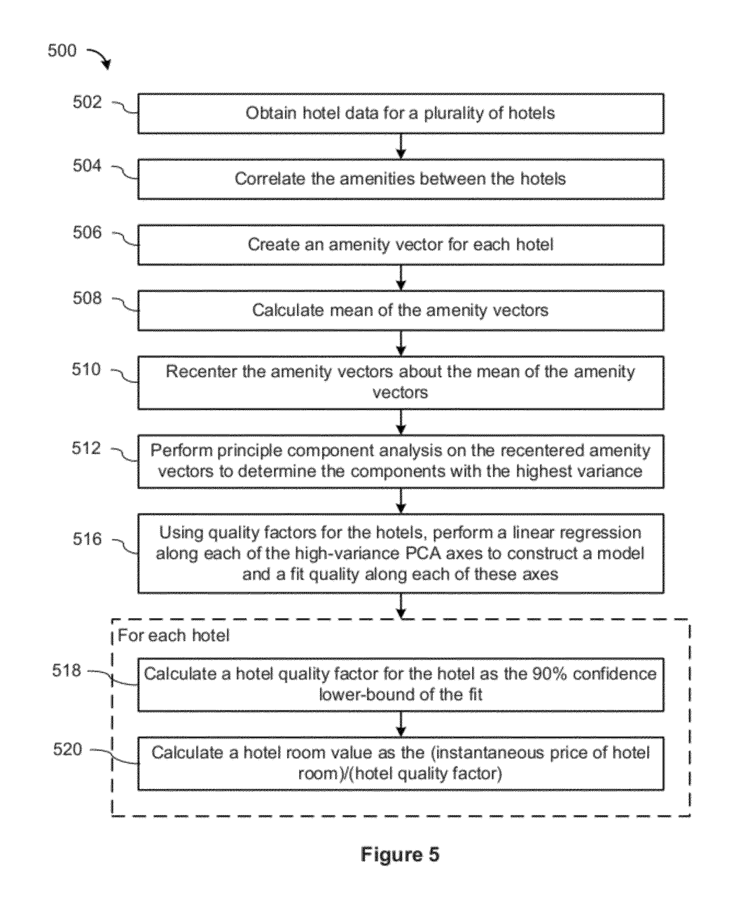

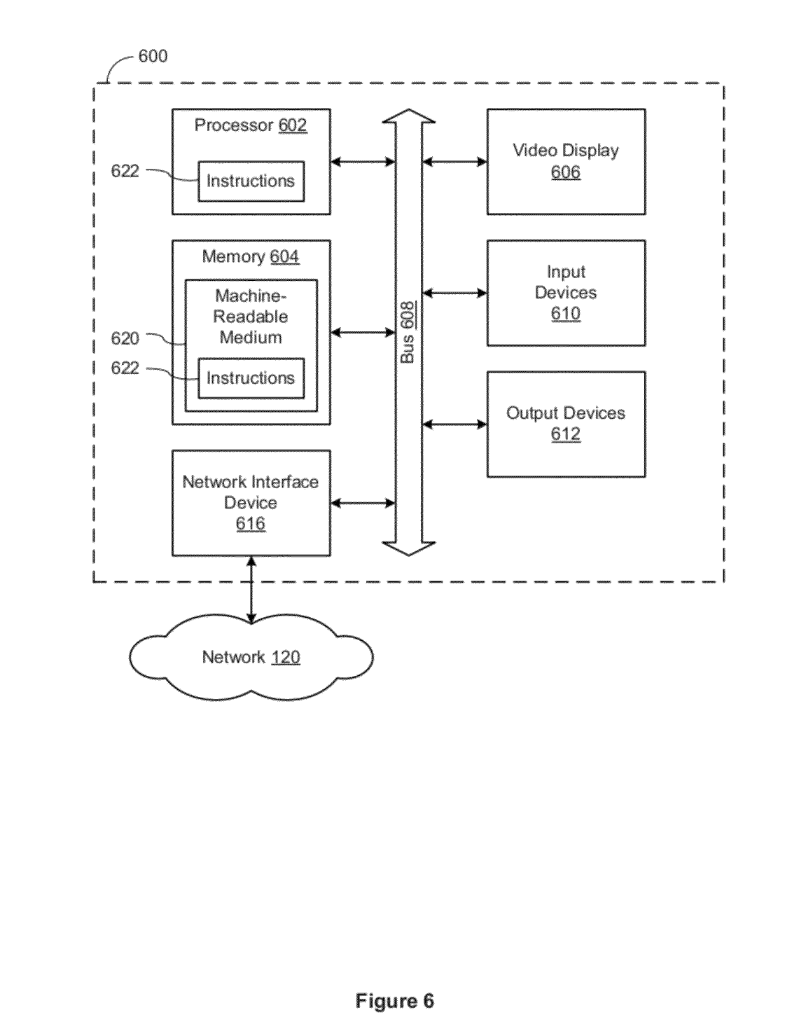

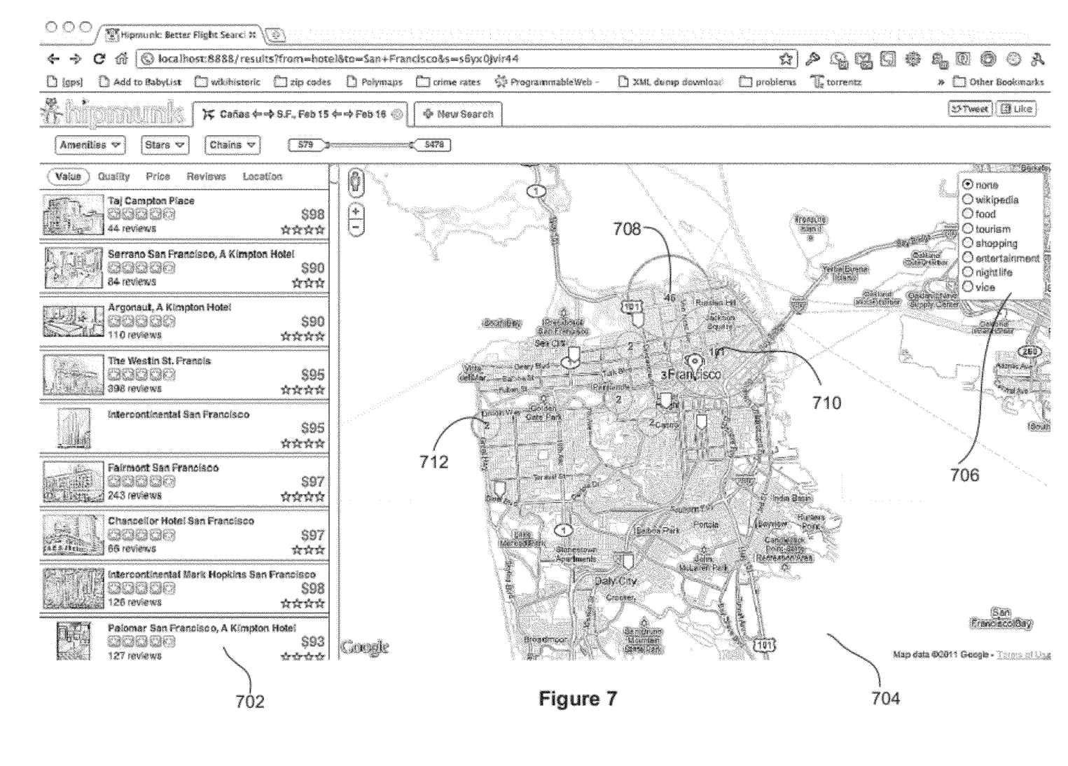

Leaving a discussion of FIG. 5-6 for later, FIG. 7 is a screenshot illustrating a user interface for presenting one or more hotel search results, according to some example embodiments. FIG. 7 includes a list of hotels 702 that satisfy a search query (e.g., a hotel search query). The list of hotels 702 may include hotel information such as a name of a hotel, a price of a hotel room, a rating of a hotel, and the like. FIG. 7 also includes a geographic map 704 that shows the locations of the hotels that satisfy the search query. The location of a hotel may be shown by an indicator (e.g., a flag, a circle, or a dot). In some example embodiments, the indicators for the hotels vary in size or color. For example, higher ranked hotels may be represented by larger indicators, while moderately ranked hotels may be represented by the moderately sized indicators, and lower ranked hotels may be represented by smaller indicators. As an additional example, more expensive hotels may be colored a brighter color or a redder color, while cheaper hotels are colored differently than the more expensive hotels. As illustrated, the locations of the hotels may be displayed in one or more clusters (e.g., hotel clusters 708, 710, and 712). Each cluster may indicate an area in which the hotels reside and the number of hotels in the cluster. In certain example embodiments, a single indicator (e.g., a flag or a dot) represents multiple hotels (e.g., in a cluster), and such a single indicator may include a numeral (e.g., as a numeric indicator) to represent the number of hotels represented by the indicator. Hotel clusters are described in more detail below.

A point of interest filter setting 706 may be used to select a type of point of interest to filter the search results.

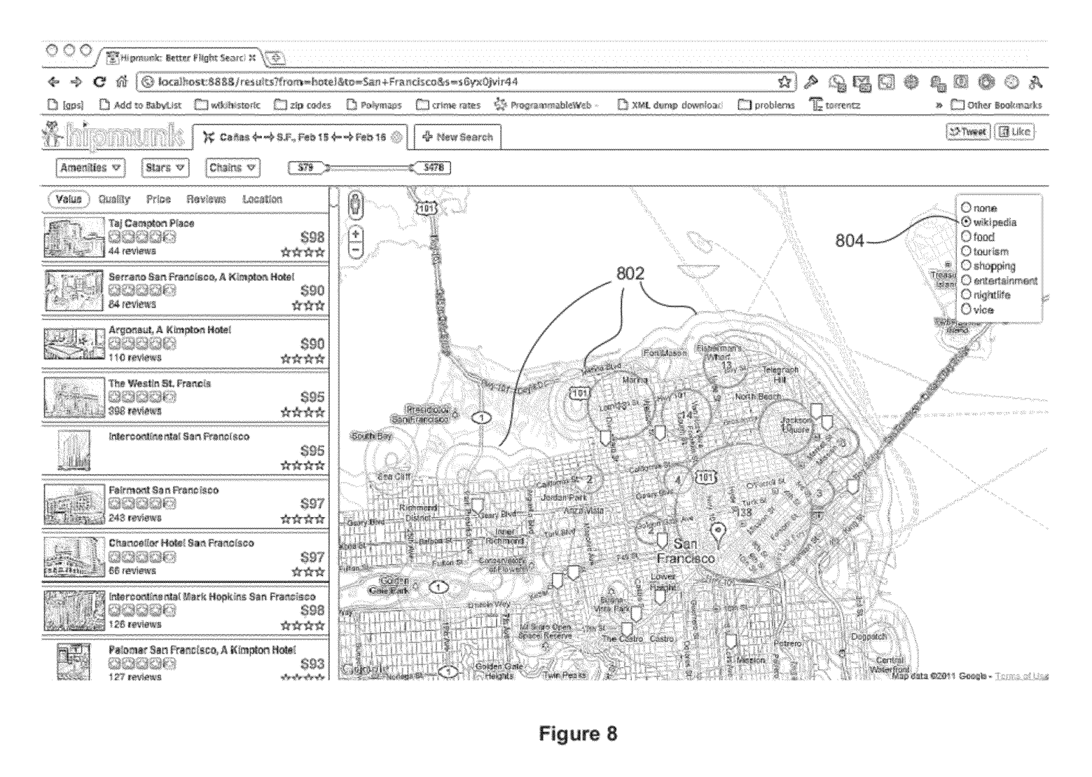

FIG. 8 is a screenshot illustrating a heat map superimposed on a geographic map, according to some example embodiments. As shown, the heat map includes contour lines 802, a color gradient, or both, to indicate the concentration (e.g., density) of points of interest. A traveler may select a point of interest filter setting 804 to change the heat map that is displayed. For example, the point of interest filter setting 804 may be changed to display the concentration of shopping establishments.

In some example embodiments, hotels may be rated using a “star” rating system that indicates the relative quality of hotels using a number of stars. Oftentimes, a hotel with more stars may be perceived to be of a better quality than a hotel with fewer stars. Unfortunately, the star rating system may not be universal, and star ratings may not be comparable between hotels.

Thus, some example embodiments provide a hotel quality factor that is derivable from the amenities of a hotel. An instantaneous price of a hotel room (e.g., an advertised price of a hotel room) may be compared to a hotel room value using such a hotel quality factor.

FIG. 5 is a flowchart of operations in a method 500 of calculating accommodation quality factors (e.g., hotel quality factors) and accommodation room values (e.g., hotel room values), according to some example embodiments.

The server 102 may obtain (at operation 502) hotel data for a plurality of hotels. In some example embodiments, the hotel data for a hotel includes a geographic location of the hotel (e.g., a global positioning system (GPS) coordinate, an address, etc.), a description of amenities available at the hotel (e.g., common amenities, room amenities, etc.), one or more prices of rooms in the hotel, a star rating of the hotel, or any suitable combination thereof.

Since there may be variations in the reported hotel amenities among hotel chains, the server 102 may correlate (at operation 504) the amenities between the hotels. For example, the server 102 may group together similar amenities that are highly anti-correlated and appear to represent the same aspect of the hotel (e.g., “Concierge” and “Concierge Desk” may indicate the same amenity).

The server 102 may create (at operation 506) an amenity vector for each hotel. Each hotel may be treated as a point in a multidimensional vector space in which one degree of freedom is assigned per amenity of the hotel. The presence or absence of an amenity in the hotel's amenity vector may be indicated using a 1 or a 0, respectively.

The server 102 may calculate (at operation 508) a mean of the amenity vectors. Given a set of N amenity vectors:

{\vec{a}ᵢ, \vec{a}₂, . . . , \vec{a}_{N}},

the mean of the amenity vectors,

\vec{a}ₘ,

may be determined as

$${\vec{a}}_{m} = \frac{{\sum }_{i}^{ } {\vec{a}}_{i}}{N}$$

(e.g., a vector sum that is normalized by the number of amenity vectors). According to various example embodiments, the mean of the amenity vectors is a vector in the same vector space as the set of N amenity vectors and represents the “center” of the amenity vectors.

The server 102 may re-center (at operation 510) the amenity vectors about the mean of the amenity vectors. Specifically, for each amenity vector

\vec{a}ᵢ

(where i is between 1 and 1V), a re-centered amenity vector

\vec{b}ᵢ

may be calculated as:

\vec{b}ᵢ=\vec{a}ᵢ−\vec{a}ₘ.

The server 102 may perform (at operation 512) principal component analysis (PCA) on the re-centered amenity vectors to determine the components (e.g., axes) with the highest variance.

Using quality factors for the hotels (e.g., combination of the hotel's average price and a “star” rating), the server 102 may perform (at operation 516) a linear regression along each of the high-variation PCA axes to construct a model and a fit quality along each of these axes.

For each hotel, the server 102 may calculate (at operation 518) a “hotel quality factor” for the hotel as the 90% confidence lower-bound of the fit and may calculate (at operation 520) a “hotel room value” as the ratio of the instantaneous price of a hotel room to the hotel quality factor:

(instantaneous price of a hotel room)/(hotel quality factor).

According to various example embodiments, the hotel quality factor and the hotel room value allow relative comparison of hotels within the same geographical area and thus may be used as the primary and secondary display sorts, respectively.

As discussed above, the server 102 may sort the hotel search results based on a number of factors. In some example embodiments, the server 102 sorts the hotel search results based on hotel room values. The client computer system 104 may also perform the sorting if the server 102 provides the client computer system 104 with the hotel room values. In some example embodiments, the server 102 sorts the hotel search results based on price differences between hotel room values and the instantaneous prices of the hotel rooms. For example, the hotels having rooms with the largest positive hotel room values (e.g., where the hotel room value exceeds the instantaneous price of the hotel room) may be sorted to the top of the results.

According to various example embodiments, the geographic map may allow a traveler to zoom in to see more details in a smaller area of the geographic map (e.g., zoom into a particular street, a particular region, etc.) and zoom out to see a larger area of the geographic map (e.g., zoom out to see the whole city, the whole state, etc.). In some embodiments, when zooming out on the geographic map, the visual indicators for the hotels are clustered so that hotels within a particular distance of each other for a particular zoom level are clustered into a single visual indicator. For example, the particular distance may be based on an absolute number of pixels on the geographic map, the number of total hotels available for a given city, or a function of the zoom level (e.g., the area of a cluster increases by a specific function of the zoom level).

In certain example embodiments, a hierarchical clustering algorithm with an adjustable cluster “size” may be used. In some example embodiments, the cluster size is set to be N pixels independent of zoom level. In doing so, as the traveler zooms in and out, the clusters shrink and grow accordingly.

In some example embodiments, a visual indicator (e.g., of a cluster of hotels) includes a number of hotels included in a cluster. As the traveler (e.g., the user) zooms in or zooms out, the value of the visual indicator decreases or increases, respectively, based on the number of hotels that are within the cluster. In some embodiments, the visual indicator includes a shape (e.g., a circle, etc.) covering an area corresponding to the geographic area included in the cluster. As the traveler zooms in or zooms out, area of the geographic map covered by a cluster decreases or increases, respectively, based on the zoom level.

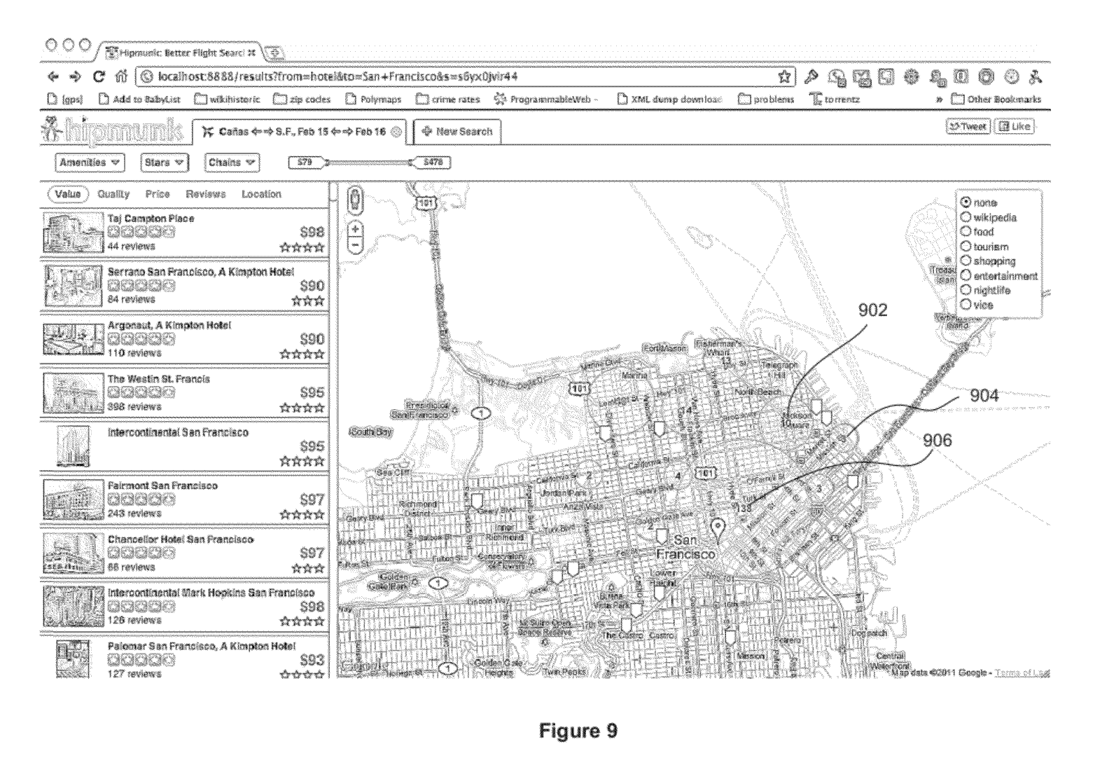

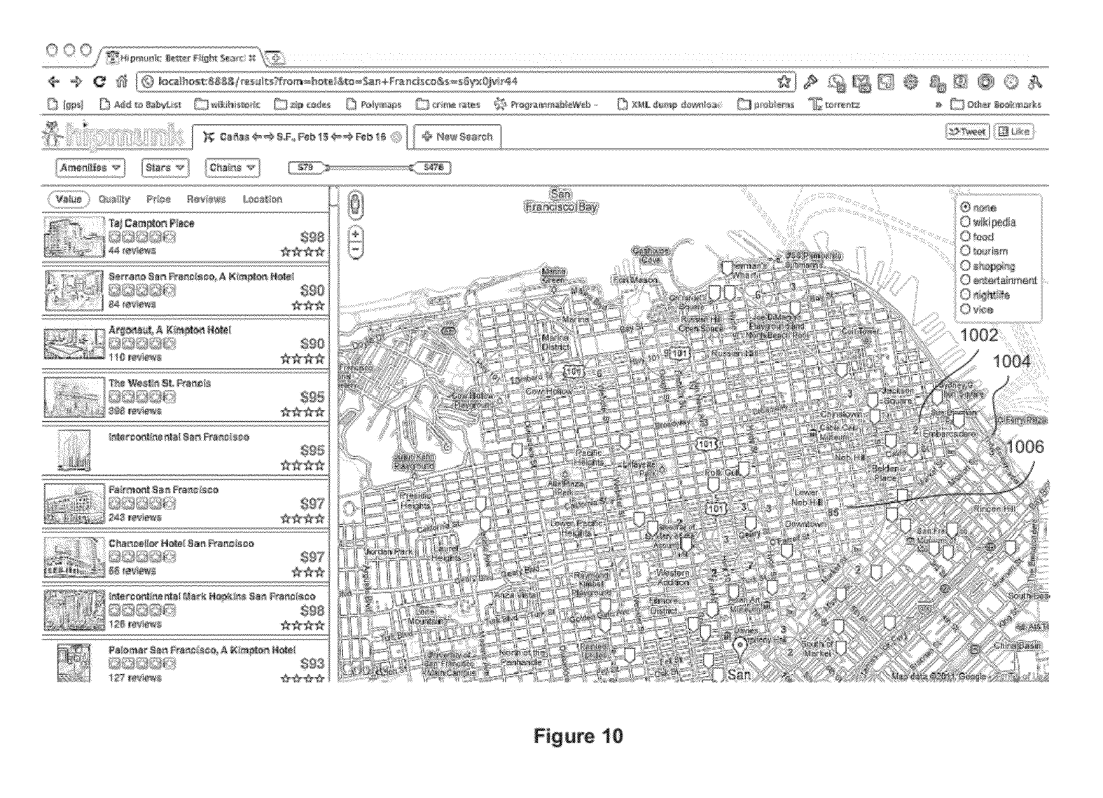

FIG. 9 is a screenshot illustrating clusters of hotels at a first zoom level, according to some example embodiments. Similarly, FIG. 10 is a screenshot illustrating clusters of hotels at a second zoom level, according to some example embodiments. In FIG. 9, hotel clusters 902, 904, and 906 (among other hotel clusters) include 10, 3, and 133 hotels, respectively. In FIG. 10, the geographic map is zoomed in. Accordingly, these clusters in FIG. 10 may occupy a smaller area in the user interface and some hotels may be grouped into other clusters. For example, the hotel clusters 1002, 1004, and 1006 (among other hotel clusters) include 2, 3, and 85 hotels, respectively. The hotel clusters 1002, 1004, and 1006 may be included in the hotel clusters 902, 904, and 906.

When a traveler (e.g., a user) searches for hotels near a particular destination, it may be desirable to also provide a contextual view of the available transportation options. For example, a traveler searching for hotels in San Francisco, Calif. may desire to know where the airports and train stations are located with respect to the hotels. Thus, some example embodiments provide a user interface element displayed in the user interface of the client computer system 104 that, when activated by the traveler, causes the client computer system 104 to automatically select a zoom level of the geographic map that includes locations of one or more transportation options. In some embodiments, the client computer system 104 automatically selects a zoom level of the geographic map that includes a predetermined number of the nearest transportation options of particular types (e.g., trains, airplanes, bus, etc.). In some example embodiments, the particular types of transportation options may be specified by the traveler or may be set to a default value by the client computer system 104.

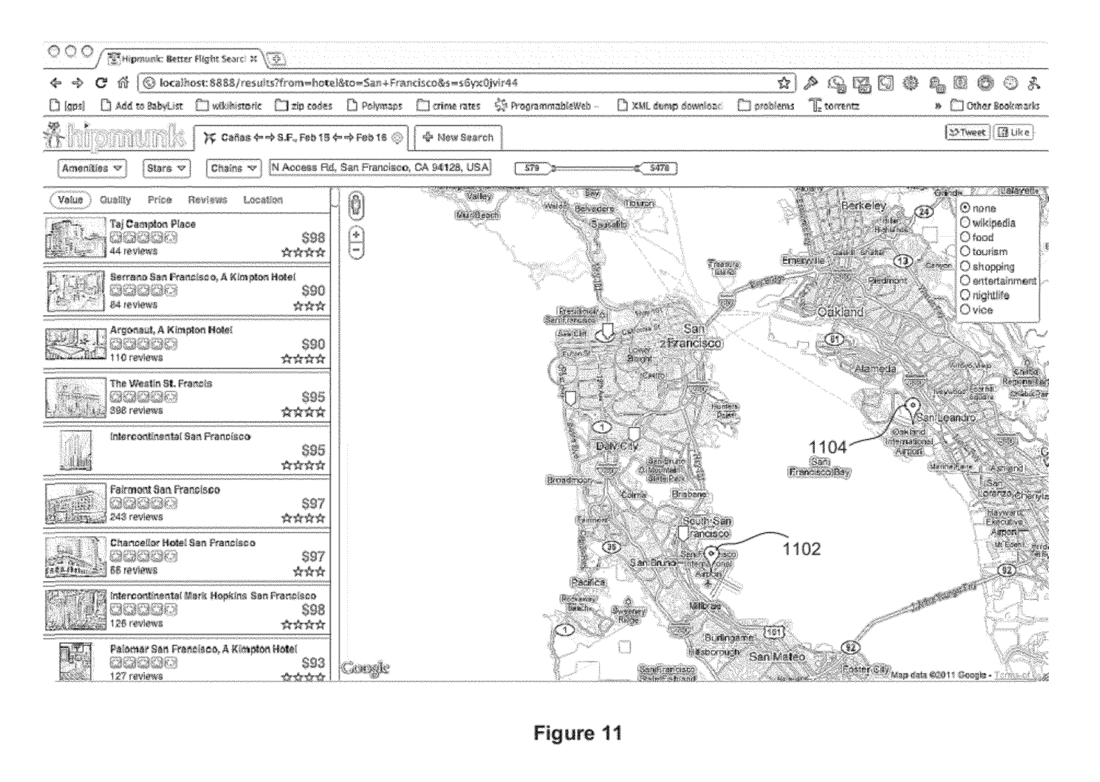

FIG. 11 is a screenshot illustrating a result of a contextual zoom-out operation, according to some example embodiments. In FIG. 11, the contextual zoom-out operation was performed on the hotel search results illustrated in FIG. 7. The geographic map is zoomed out so that the airports 1102 and 1104 are displayed on the geographic map.

Although the discussion above discusses allowing a traveler to locate hotels that are near particular concentrations of points of interest at or near a destination, a traveler (e.g., a user) may desire to locate hotels that are nearest to multiple specific points of interest at or near a destination. In other words, some example embodiments allow a traveler provide a submission that specifies one or more particular points of interest that are at or near a destination so that hotels near the traveler-specified points of interest may be ranked more highly, highlighted, or otherwise identified in the user interface displayed by the client computer system 104. According to various example embodiments, such a submission may be received (e.g., with the hotel search query) by the server 102, the client computer system 104, or both. For example, a traveler may specify a destination of San Francisco, Calif., but may desire to locate a hotel that is near Fisherman's Wharf, the San Francisco Museum of Modern Art, and Golden Gate Park. Thus, some example embodiments facilitate sorting of hotels based on distances of the hotels from a plurality of points of interest. The multiple points of interest may be indicated by the traveler by placing pin points or other visual indicators on the geographic map displayed in the user interface of the client computer system 104. According to various example embodiments, the pin points may correspond to actual points of interest or to any point on the geographic map that the traveler desires to mark.

In some example embodiments, the client computer system 104 sorts the hotels based on the distances of the hotels from multiple points of interest.

In certain example embodiments, the client computer system 104 sends the desired points of interest (e.g., the locations of the pin points) to the server 102. In these embodiments, the server 102 sorts the hotels based on the distances of the hotels from multiple points of interest and transmits the results back to the client computer system 104.

In various example embodiments, a composite score is calculated (e.g., by the server 102 or by the client computer system 104) for each hotel based on the distance of the hotel from each of the points of interest. The composite score may then be used to sort the hotels.

In some example embodiments, the composite scores are calculated (e.g., by the client computer system 104) as follows. The client computer system 104 may calculate the center of the points of interest (e.g., by calculating a mean of the two-vectors based on the GPS coordinates of the points of interest). For each hotel, the client computer system 104 may calculate the distance of the hotel from the center of the points of interest. The client computer system 104 may sort the hotels based on the distance of the hotels from the center of the points of interest.

In certain example embodiments, the composite score for a hotel is a function of an inverse of the distance of the hotel to the destination or a preferred point of interest (e.g.,

$$\frac{1}{{d}_{id}} ,$$

where d_{id} is a distance of a hotel i to a destination d) and a sum of the inverse of the distances of the hotel to each point of interest (e.g.,

$${\sum }_{n}^{ } \frac{1}{{d}_{in}} ,$$

where dᵢₙ is a distance of a hotel i to a point of interest n). The function of these two factors may allow the composite score to be weighted so that a hotel that is closer to the destination or the preferred point of interest is ranked higher than a hotel that is farther from the destination or the preferred point of interest.

FIG. 6 depicts a block diagram of a machine in the example form of a computer system 600 within which may be executed a set of instructions for causing the machine to perform any one or more of the methodologies discussed herein, according to some example embodiments. In alternative example embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment. The computer system 600 may include, but is not limited to, a desktop computer system, a laptop computer system, a server, a mobile phone, a smart phone, a personal digital assistant (PDA), a gaming console, a portable gaming console, a set top box, a camera, a printer, a television set, or any other electronic device.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computer system 600 includes a processor 602 (e.g., a central processing unit (CPU), a graphics processing unit (GPU) or both), and memory 604, which communicate with each other via bus 608. Memory 604 includes volatile memory devices (e.g., DRAM, SRAM, DDR RAM, or other volatile solid state memory devices), non-volatile memory devices (e.g., magnetic disk memory devices, optical disk memory devices, flash memory devices, tape drives, or other non-volatile solid state memory devices), or a combination thereof. Memory 604 may optionally include one or more storage devices remotely located from the computer system 600. The computer system 600 may further include a video display unit 606 (e.g., a plasma display, a liquid crystal display (LCD) or a cathode ray tube (CRT)). The computer system 600 also includes input devices 610 (e.g., keyboard, mouse, trackball, touchscreen display, etc.), output devices 612 (e.g., speakers), and a network interface device 616. The aforementioned components of the computer system 600 may be located within a single housing or case (e.g., as depicted by the dashed lines in FIG. 6). Alternatively, a subset of the components may be located outside of the housing. For example, the video display unit 606, the input devices 610, and the output devices 612 may exist outside of the housing, but be coupled to the bus 608 via external ports or connectors accessible on the outside of the housing.

Memory 604 includes a machine-readable medium 620 on which is stored one or more sets of data structures and instructions 622 (e.g., software) embodying or utilized by any one or more of the methodologies or functions described herein. The one or more sets of data structures may store data. Note that a machine-readable medium refers to a storage medium that is readable by a machine (e.g., a computer-readable storage medium). The data structures and instructions 622 may also reside, completely or at least partially, within memory 604 and/or within the processor 602 during execution thereof by computer system 600, with memory 604 and processor 602 also constituting machine-readable, tangible media.

The data structures and instructions 622 may further be transmitted or received over a network 120 via network interface device 616 utilizing any one of a number of well-known transfer protocols (e.g., HyperText Transfer Protocol (HTTP)).

Certain embodiments are described herein as including logic or a number of components, modules, or mechanisms. For example, any one or more operations in the above-discussed example methods may be performed by a processor-implemented module (e.g., a processor configured by a module to perform the one or more operations). Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 600) or one or more hardware modules of a computer system (e.g., a processor 602 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 602 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 602 configured using software, the general-purpose processor 602 may be configured as respective different hardware modules at different times. Software may accordingly configure a processor 602, for example, to constitute a particular hardware module at one instance of time and to constitute a different hardware module at a different instance of time.

Modules may be configured to provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 602 that are temporarily configured (e.g., by software, code, and/or instructions stored in a machine-readable medium) or permanently configured to perform the relevant operations. Whether temporarily or permanently configured, such processors 602 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 602 or processor-implemented (or computer-implemented) modules. Similarly, at least some of the operations of a method may be governed by instructions that are stored in a computer readable storage medium and executed by one or more processors 602 or processor-implemented (or computer-implemented) modules. The performance of certain of the operations may be distributed among the one or more processors 602, not only residing within a single machine, but deployed across a number of machines. In some example embodiments, the processors 602 may be located in a single location (e.g., within a home environment, an office environment or as a server farm), while in other embodiments the processors 602 may be distributed across a number of locations.

While the embodiment(s) is (are) described with reference to various implementations and exploitations, it will be understood that these embodiments are illustrative and that the scope of the embodiment(s) is not limited to them. In general, techniques for the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and its practical applications, to thereby enable others skilled in the art to best utilize the embodiments and various embodiments with various modifications as are suited to the particular use contemplated.

The following enumerated descriptions define various example embodiments of methods, systems (e.g., apparatus), and non-transitory computer readable storage media discussed herein:

1. A method comprising:
receiving an accommodation search query from a client computer system, the accommodation search query specifying a destination for travel;
generating a heat map indicative of a concentration of points of interest within a vicinity of the destination specified in the accommodation search query;
identifying an accommodation based on the concentration of points of interest within the vicinity of the destination specified in the accommodation search query,
the identifying of the accommodation being performed by a processor of a machine; and
transmitting the heat map and accommodation data descriptive of the identified accommodation to the client computer system, the accommodation data and the heat maps being displayable on a geographic map on the client computer system.

2. The method of claim 1 further comprising:
obtaining map tiles that correspond to geographic locations within a predetermined distance of the destination for travel specified in the accommodation search query.

3. The method of claim 2, wherein:
the obtaining of the map tiles includes obtaining a first set of map tiles for a first level of zoom of a geographic map and obtaining a second set of map tiles for a second level of zoom of the geographic map.

4. The method of claim 2, wherein:
the obtaining of the map tiles includes obtaining the map tiles for multiple levels of zoom in a geographic map.

5. The method of claim 1, wherein:
the generating of the heat map includes generating a contour line within the heat map.

6. The method of claim 1, wherein:
the generating of the heat map includes generating a color gradient within the heat map.

7. The method of claim 1, wherein:
the generating of the heat map includes determining a set of points of interest within a map tile of a geographic map and adding the set of points of interest to a Gaussian blob that has a predetermined standard deviation for a zoom level.

8. The method of claim 7, wherein:
the generating of the heat map includes determining the predetermined standard deviation for the zoom level.

9. The method of claim 1, wherein:
the generating of the heat map includes normalizing a map tile of a geographic map to a predetermined contrast level with respect to a further map tile of the geographic map.

10. The method of claim 1, wherein:
the generating of the heat map includes interpolating a normalization array for a map tile of a geographic map.

11. The method of claim 10, wherein:
the interpolating of the normalization array is linear and includes fitting a number of neighboring map tiles around the map tile of the geographic map to a predetermined number of planes.

12. The method of claim 1, wherein:
the transmitting of the heat map and of the accommodation data includes transmitting map tiles of a geographic map, the map tiles indicating locations within a predetermined distance of the destination for travel.

13. The method of claim 1, wherein:
the receiving of the accommodation search query includes receiving a submission of a traveler-specified point of interest; and
the identifying of the accommodation is further based on the traveler-specified point of interest.

14. A non-transitory machine-readable storage medium comprising instructions that, when executed by one or more processors of a machine, cause the machine to perform operations comprising:
receiving an accommodation search query from a client computer system, the accommodation search query specifying a destination for travel;
generating a heat map indicative of a concentration of points of interest within a vicinity of the destination specified in the accommodation search query;
identifying an accommodation based on the concentration of points of interest within the vicinity of the destination specified in the accommodation search query, the identifying of the accommodation being performed by the one or more processors of the machine; and
transmitting the heat map and accommodation data descriptive of the identified accommodation to the client computer system, the accommodation data and the heat maps being displayable on a geographic map on the client computer system.

15. The non-transitory machine-readable storage medium of claim 14, wherein:
the receiving of the accommodation search query includes receiving a submission of a traveler-specified point of interest; and
the identifying of the accommodation is further based on the traveler-specified point of interest.

16. A system comprising:
a processor configured by instructions that configure the processor to:
receive an accommodation search query from a client computer system, the accommodation search query specifying a destination for travel;
generate a heat map indicative of a concentration of points of interest within a vicinity of the destination specified in the accommodation search query;
identify an accommodation based on the concentration of points of interest within the vicinity of the destination specified in the accommodation search query; and
transmit the heat map and accommodation data descriptive of the identified accommodation to the client computer system, the accommodation data and the heat maps being displayable on a geographic map on the client computer system; and
a memory configured to store the instructions.

17. The system of claim 16, wherein:
the processor is configured by instructions to receive a submission of a traveler-specified point of interest; and
the processor is configured to perform the identifying of the accommodation based on the traveler-specified point of interest.

18. A system comprising:
a reception module configured to receive an accommodation search query from a client computer system, the accommodation search query specifying a destination for travel;
a generation module configured to generate a heat map indicative of a concentration of points of interest within a vicinity of the destination specified in the accommodation search query;
a processor configured by an identification module to identify an accommodation based on the concentration of points of interest within the vicinity of the destination specified in the accommodation search query; and
a transmission module configured to transmit the heat map and accommodation data descriptive of the identified accommodation to the client computer system, the accommodation data and the heat maps being displayable on a geographic map on the client computer system.

19. The system of claim 18, wherein:
the reception module is configured to receive a submission of a traveler-specified point of interest; and
the identification module is configured to identify the accommodation based on the traveler-specified point of interest.

20. The system of claim 18, wherein:
the transmission module is configured to transmit map tiles of a geographic map that indicate locations within a predetermined distance of the destination for travel.

21. A method comprising:
obtaining accommodation data for a plurality of accommodations, the accommodation data describing amenities for each accommodation in the plurality of accommodations;
determining a set of amenities indicative of a value of an accommodation by performing a principal component analysis based on amenity vectors generated from the accommodation data;
constructing an accommodation value model using the set of amenities that are indicative of the value of the accommodation, the constructing of the accommodation value model being performed by a processor of a machine;
calculating an accommodation quality factor for each accommodation in the plurality of accommodations based on the accommodation value model; and
calculating an accommodation room value for each accommodation in the plurality of accommodations based on the accommodation value model.

22. The method of claim 21 further comprising:
generating the amenity vectors from the accommodation data that describes the amenities for each accommodation in the plurality of accommodations.

23. The method of claim 21 further comprising:
calculating a mean of the amenity vectors generated from the accommodation data that describes the amenities for each accommodation in the plurality of accommodations; and
re-centering the amenity vectors about the calculated mean; wherein the principal component analysis is performed on the re-centered amenity vectors.

24. The method of claim 21 further comprising:
sorting a list of accommodation search results based on the calculated accommodation quality factor for each accommodation in the plurality of accommodations.

25. The method of claim 21 further comprising:
sorting a list of accommodation search results based on the calculated accommodation room value for each accommodation in the plurality of accommodations.

26. The method of claim 21 further comprising:
correlating the amenities described in the accommodation data by grouping together subsets of amenities determined to be similar to each other.

27. A non-transitory machine-readable storage medium comprising instructions that, when executed by one or more processors of a machine, cause the machine to perform operations comprising:
obtaining accommodation data for a plurality of accommodations, the accommodation data describing amenities for each accommodation in the plurality of accommodations;
determining a set of amenities indicative of a value of an accommodation by performing a principal component analysis based on amenity vectors generated from the accommodation data;
constructing an accommodation value model using the set of amenities that are indicative of the value of the accommodation, the constructing of the accommodation value model being performed by the one or more processors of the machine;
calculating an accommodation quality factor for each accommodation in the plurality of accommodations based on the accommodation value model; and
calculating an accommodation room value for each accommodation in the plurality of accommodations based on the accommodation value model.

28. The non-transitory machine-readable storage medium of claim 27, wherein the operations further comprise:
generating the amenity vectors from the accommodation data that describes the amenities for each accommodation in the plurality of accommodations.

29. The non-transitory machine-readable storage medium of claim 27, wherein the operations further comprise:
calculating a mean of the amenity vectors generated from the accommodation data that describes the amenities for each accommodation in the plurality of accommodations; and
re-centering the amenity vectors about the calculated mean; and wherein the principal component analysis is performed on the re-centered amenity vectors.

30. The non-transitory machine-readable storage medium of claim 27, wherein the operations further comprise:
sorting a list of accommodation search results based on the calculated accommodation quality factor for each accommodation in the plurality of accommodations.

31. The non-transitory machine-readable storage medium of claim 27, wherein the operations further comprise:
sorting a list of accommodation search results based on the calculated accommodation room value for each accommodation in the plurality of accommodations.

32. The non-transitory machine-readable storage medium of claim 27, wherein the operations further comprise:
correlating the amenities described in the accommodation data by grouping together subsets of amenities determined to be similar to each other.

33. A system comprising:
a processor configured by instructions that configure the processor to:
obtain accommodation data for a plurality of accommodations, the accommodation data describing amenities for each accommodation in the plurality of accommodations;
determine a set of amenities indicative of a value of an accommodation by performing a principal component analysis based on amenity vectors generated from the accommodation data;
construct an accommodation value model using the set of amenities that are indicative of the value of the accommodation;
calculate an accommodation quality factor for each accommodation in the plurality of accommodations based on the accommodation value model; and
calculate an accommodation room value for each accommodation in the plurality of accommodations based on the accommodation value model; and
a memory configured to store the instructions.

34. The system of claim 33, wherein the processor is further configured to:
calculate a mean of the amenity vectors generated from the accommodation data that describes the amenities for each accommodation in the plurality of accommodations; and
re-center the amenity vectors about the calculated mean; and wherein the principal component analysis is performed on the re-centered amenity vectors.

35. A system comprising:
an amenity module configured to obtain accommodation data for a plurality of accommodations, the accommodation data describing amenities for each accommodation in the plurality of accommodations;
an analysis module configured to determine a set of amenities indicative of a value of an accommodation by performing a principal component analysis based on amenity vectors generated from the accommodation data;
a model module configured to construct an accommodation value model using the set of amenities that are indicative of the value of the accommodation, the constructing of the accommodation value model being performed by a processor of a machine;
a processor configured by a quality module to calculate an accommodation quality factor for each accommodation in the plurality of accommodations based on the accommodation value model; and
a value module configured to calculate an accommodation room value for each accommodation in the plurality of accommodations based on the accommodation value model.

36. The system of claim 35, wherein:
the amenity module is configured to generate the amenity vectors from the accommodation data that describes the amenities for each accommodation in the plurality of accommodations.

37. The system of claim 35, wherein:
the amenity module is configured to calculate a mean of the amenity vectors generated from the accommodation data that describes the amenities for each accommodation in the plurality of accommodations;
the amenity module is configured to re-center the amenity vectors about the calculated mean; and
the analysis module is configured to perform the principal component analysis on the re-centered amenity vectors.

38. The system of claim 35 further comprising:
a sort module configured to sort a list of accommodation search results based on the calculated accommodation quality factor for each accommodation in the plurality of accommodations.

39. The system of claim 35 further comprising:
a sort module configured to sort a list of accommodation search results based on the calculated accommodation room value for each accommodation in the plurality of accommodations.

40. The system of claim 35, wherein:
the amenity module is configured to correlate the amenities described in the accommodation data by grouping together subsets of amenities determined to be similar to each other.

What is claimed is:

1. A method comprising:
obtaining accommodation data for a plurality of accommodations,
the accommodation data describing amenities for each accommodation in the plurality of accommodations;
determining a set of amenities indicative of a value of an accommodation by performing a principal component analysis based on amenity vectors generated from the accommodation data;
constructing an accommodation value model using the set of amenities that are indicative of the value of the accommodation,
the constructing of the accommodation value model being performed by a processor of a machine;
calculating an accommodation quality factor for each accommodation in the plurality of accommodations based on the accommodation value model; and
calculating an accommodation room value for each accommodation in the plurality of accommodations based on the accommodation value model.

2. The method of claim 1 further comprising:
generating the amenity vectors from the accommodation data that describes the amenities for each accommodation in the plurality of accommodations.

3. The method of claim 1 further comprising:
calculating a mean of the amenity vectors generated from the accommodation data that describes the amenities for each accommodation in the plurality of accommodations; and
re-centering the amenity vectors about the calculated mean; wherein
the principal component analysis is performed on the re-centered amenity vectors.

4. The method of claim 1 further comprising:
sorting a list of accommodation search results based on the calculated accommodation quality factor for each accommodation in the plurality of accommodations.

5. The method of claim 1 further comprising:
sorting a list of accommodation search results based on the calculated accommodation room value for each accommodation in the plurality of accommodations.

6. The method of claim 1 further comprising:
correlating the amenities described in the accommodation data by grouping together subsets of amenities determined to be similar to each other.

7. A non-transitory machine-readable storage medium comprising instructions that, when executed by one or more processors of a machine, cause the machine to perform operations comprising:
obtaining accommodation data for a plurality of accommodations,
the accommodation data describing amenities for each accommodation in the plurality of accommodations;
determining a set of amenities indicative of a value of an accommodation by performing a principal component analysis based on amenity vectors generated from the accommodation data;
constructing an accommodation value model using the set of amenities that are indicative of the value of the accommodation,
the constructing of the accommodation value model being performed by the one or more processors of the machine;
calculating an accommodation quality factor for each accommodation in the plurality of accommodations based on the accommodation value model; and
calculating an accommodation room value for each accommodation in the plurality of accommodations based on the accommodation value model.

8. The non-transitory machine-readable storage medium of claim 7, wherein the operations further comprise:
generating the amenity vectors from the accommodation data that describes the amenities for each accommodation in the plurality of accommodations.

9. The non-transitory machine-readable storage medium of claim 7, wherein the operations further comprise:
calculating a mean of the amenity vectors generated from the accommodation data that describes the amenities for each accommodation in the plurality of accommodations; and
re-centering the amenity vectors about the calculated mean; and wherein
the principal component analysis is performed on the re-centered amenity vectors.

10. The non-transitory machine-readable storage medium of claim 7, wherein the operations further comprise:
sorting a list of accommodation search results based on the calculated accommodation quality factor for each accommodation in the plurality of accommodations.

11. The non-transitory machine-readable storage medium of claim 7, wherein the operations further comprise:
sorting a list of accommodation search results based on the calculated accommodation room value for each accommodation in the plurality of accommodations.

12. The non-transitory machine-readable storage medium of claim 7, wherein the operations further comprise:
correlating the amenities described in the accommodation data by grouping together subsets of amenities determined to be similar to each other.

13. A system comprising:
a processor configured by instructions that configure the processor to:
obtain accommodation data for a plurality of accommodations,
the accommodation data describing amenities for each accommodation in the plurality of accommodations;
determine a set of amenities indicative of a value of an accommodation by performing a principal component analysis based on amenity vectors generated from the accommodation data;
construct an accommodation value model using the set of amenities that are indicative of the value of the accommodation;
calculate an accommodation quality factor for each accommodation in the plurality of accommodations based on the accommodation value model; and
calculate an accommodation room value for each accommodation in the plurality of accommodations based on the accommodation value model; and
a memory configured to store the instructions.

14. The system of claim 13, wherein the processor is further configured to:
calculate a mean of the amenity vectors generated from the accommodation data that describes the amenities for each accommodation in the plurality of accommodations; and
re-center the amenity vectors about the calculated mean; and wherein
the principal component analysis is performed on the re-centered amenity vectors.

15. A system comprising:
an amenity module configured to obtain accommodation data for a plurality of accommodations,
the accommodation data describing amenities for each accommodation in the plurality of accommodations;
an analysis module configured to determine a set of amenities indicative of a value of an accommodation by performing a principal component analysis based on amenity vectors generated from the accommodation data;
a model module configured to construct an accommodation value model using the set of amenities that are indicative of the value of the accommodation,
the constructing of the accommodation value model being performed by a processor of a machine;
a processor configured by a quality module to calculate an accommodation quality factor for each accommodation in the plurality of accommodations based on the accommodation value model; and
a value module configured to calculate an accommodation room value for each accommodation in the plurality of accommodations based on the accommodation value model.

16. The system of claim 15, wherein:
the amenity module is configured to generate the amenity vectors from the accommodation data that describes the amenities for each accommodation in the plurality of accommodations.

17. The system of claim 15, wherein:
the amenity module is configured to calculate a mean of the amenity vectors generated from the accommodation data that describes the amenities for each accommodation in the plurality of accommodations;
the amenity module is configured to re-center the amenity vectors about the calculated mean; and
the analysis module is configured to perform the principal component analysis on the re-centered amenity vectors.

18. The system of claim 15 further comprising:
a sort module configured to sort a list of accommodation search results based on the calculated accommodation quality factor for each accommodation in the plurality of accommodations.

19. The system of claim 15 further comprising:
a sort module configured to sort a list of accommodation search results based on the calculated accommodation room value for each accommodation in the plurality of accommodations.

20. The system of claim 15, wherein:
the amenity module is configured to correlate the amenities described in the accommodation data by grouping together subsets of amenities determined to be similar to each other.
